(19) United States
(12) Patent Application Publication
(10) Pub. No.: US 2026/0185601 A1
(43) Pub. Date: Jul. 2, 2026

(54) SUPPLY DEVICE FOR SUPPLYING LUBRICANT, SYSTEM FOR SUPPLYING LUBRICANT TO A ROLLING ELEMENT BEARING, AND TRANSMISSION FOR A VEHICLE

(71) Applicant: Schaeffler Technologies AG & Co. KG, Herzogenaurach (DE)

(72) Inventors: Johann Averichev, Nuernberg (DE); Sarah Sponsel, Aurachtal (DE); Roselina Postler, Aurachtal (DE); Peter Welker, Herzogenaurach (DE); Peter Spál, Kysucke Nove mesto (SK)

(73) Assignee: Schaeffler Technologies AG & Co. KG, Herzogenaurach (DE)

(21) Appl. No.: 18/859,163

(22) PCT Filed: Mar. 13, 2023
(86) PCT No.: PCT/DE2023/100188

§ 371 Date: Oct. 23, 2024

(30) Foreign Application Priority Data
Apr. 26, 2022 (DE) 10 2022 110 027.8

(51) Int. Cl. F16H 57/04

(52) U.S. Cl. CPC F16H 57/0423

(57) ABSTRACT

A supply device for supplying a lubricant to at least one rolling bearing or at least one gear in a transmission housing includes a lubricant channel having at least two path segments. The at least two path segments are arranged at an angle to one another in order to circumvent an obstacle within the transmission housing. The lubricant channel may have a first path segment and a second path segment, and the first path segment and the second path segment may form an L-shape.

### CROSS-REFERENCE TO RELATED APPLICATIONS

This application is the United States National Phase of PCT Appln. No. PCT/DE2023/100188 filed Mar. 13, 2023, which claims priority to German Application No. DE102022110027.8 filed Apr. 26, 2022, the entire disclosures of which are incorporated by reference herein.

### TECHNICAL FIELD

The present disclosure relates to a supply device for supplying lubricant to at least one rolling bearing and/or at least one gear in a transmission housing, a system for supplying lubricant to a rolling bearing in the interior of a transmission housing and a transmission for a vehicle.

### BACKGROUND

It is known that a conventional transmission in a conventional vehicle with an internal combustion engine, for example, is designed in such a manner that the wear-critical components of the transmission are continuously supplied with lubricant when the vehicle is traveling forwards. When it comes to reversing a vehicle, on the other hand, which normally plays a subordinate role, as the transmission does not suffer any damage in the short time of a normal reverse travel due to the low loads and little time spent, not much attention has so far been paid to the supply of lubricant to the transmission. As such, the pumping direction of the gears (due to the helical toothing) and the bearings is also designed in such a manner that they only pump the lubricant to the wear-critical components or points during forward travel.

In the course of the growing electrification of vehicles and with the development of self-driving vehicles, such as shuttle buses or taxi cabs, tried-and-tested transmissions from the field of combustion engines are currently being utilized or used as a foundation for further development. One aspect in this regard is the optimization of installation space and thus also weight in order to increase the range of a vehicle.

It is well known in this regard that, in particular, self-driving vehicles, such as shuttle buses or taxi cabs, travel in reverse to a considerable extent and that the proportion of journeys in both directions (forwards and in reverse) is significantly greater than in the case of a conventional car. As a result, wear-critical components or points in a transmission are lubricated or oiled less.

DE 101 19 573 A1, for example, describes an oil supply device for spur gears. This includes a linearly extending oil collecting channel arranged on movable elements of a shifting device, which moves along with the elements (such as shift rockers or shift forks) and which extends through the entire part in the transmission housing, which has gears. Furthermore, the oil supply device has an opening that covers regions within the transmission housing where bearings and toothings are arranged when the elements of the shifting device move. This allows for an additional lubrication of wear-critical components in a transmission.

However, this design of the oil supply device requires sufficient space in a transmission and may be unsuitable for planetary transmissions, which, due to their design, require a different amount of installation space than spur gears do.

Of course, other concepts for wear reduction using a lubricant or oil also exist, such as splash lubrication or central lubrication—as mentioned by way of example in DE 101 19 573 A1.

In summary, in the above embodiments transmissions for self-driving vehicles, for example, may experience a poor supply of lubricant when traveling in reverse, for example, due to the optimization of installation space and the associated weight optimization as well as the pumping direction of the gears (due to the helical toothing), leading to an increase in wear and also of the temperature of the transmission components.

### SUMMARY

The present disclosure provides a supply device for supplying lubricant to at least one rolling bearing and/or at least one gear in a transmission housing, a system for supplying lubricant to at least one rolling bearing and/or at least one gear and a transmission for a vehicle with a lubricant supply in both directions of travel and a planetary gear transmission, in which a sufficient supply of lubricant to rolling bearings and/or gears can be ensured when a vehicle, such as an electric vehicle, is traveling both forwards and in reverse.

A first aspect of the present disclosure includes a supply device for supplying lubricant to at least one rolling bearing and/or at least one gear in a transmission housing. The supply device can be designed to be fastened at least partially or in sections to a transmission housing. In other words, the supply device can be suitable for fastening to a transmission housing.

In this regard, the supply device includes a lubricant channel having at least two path segments. The at least two path segments are arranged at an angle to one another in order to circumvent an obstacle, such as a planetary transmission or a shifting device for shifting gears of a transmission, within a transmission housing. In this way, lubricant can also be collected at a position with sufficient lubricant during reverse travel, for example, in which lubricant is conveyed away from a bearing to be lubricated (for example due to the pumping effect of a helical toothing), and guided or directed to a bearing to be lubricated or to a gear to be lubricated or to a gear pairing to be lubricated.

The lubricant channel can be formed integrally or in one piece. The lubricant channel can also be made of plastic. Both of these embodiments, either individually or together, allow for a simple and cost-effective production.

In addition, the lubricant channel can include a first path segment and a second path segment. The first path segment and the second path segment can be connected to one another.

The first path segment and the second path segment can form an angle of at least 45 degrees and at most 90 degrees to one another. The first path segment and the second path segment can also form an angle of 90 degrees to one another.

The first path segment and the second path segment can also form an L-shape together.

With both the L-shaped and the angled design, a sufficient circumvention of an obstacle in a transmission housing, such as a shift fork or a shifting device, can be provided.

Furthermore, the lubricant channel can be designed such that lubricant filled into the lubricant channel flows from a first end of the lubricant channel to a second end of the lubricant channel. This allows the flow direction of the lubricant to be determined.

Furthermore, the lubricant channel can include a first end and a second end.

The first path segment can include the first end and the second path segment can include the second end.

Furthermore, the lubricant channel can have an open side for the inflow of lubricant and a closed side, which can be formed by a bottom part of the lubricant channel. This makes production easier and also allows any lubricant that splashes around to be collected and directed to its intended destination.

Described in more simple terms, the lubricant channel can be designed akin to a roof gutter or playground slide.

The lubricant channel can include a bottom part, a first side part and a second side part, which together form a U-shaped cross-section. This allows for a guide for the lubricant to be created in a simple manner.

Furthermore, the lubricant channel or its bottom part can have a slope so that lubricant can flow or be guided along the lubricant channel from a first end of the lubricant channel to a second end of the lubricant channel.

In addition, the supply device can have an inflow device and a discharge device for receiving lubricant at one location and discharging it at another location.

The inflow device can be arranged at a first end of the lubricant channel.

Furthermore, the inflow device can include a first path segment of the lubricant channel.

Alternatively or additionally, the inflow device can have a tubular or a generally cylindrical segment through which lubricant can flow.

In the present description, a generally cylindrical segment can be understood as a shape described by a generalized cylinder. Such a generalized cylinder includes any curvilinear course within a plane which is displaced along a certain distance, wherein the distance is not included in the plane in which the generalized cylinder has any curvilinear course. Such a generalized cylinder is also known from the field of mathematics.

Furthermore, the segment of the inflow device can open into one of the at least two path segments, for example into a first path segment of the lubricant channel, in order to additionally supply the at least one path segment with lubricant.

In addition, the inflow device or the segment can be arranged on a first side part of the lubricant channel and connected to it in a fluid-communicating manner. This allows lubricant to flow from the segment into the lubricant channel, for example.

In this regard, the inflow device or segment can have the task of collecting this lubricant from another region of a transmission where sufficient lubricant is available and directing it into the lubricant channel. This means that lubricant can be received at one location and discharged at another.

The discharge device can be arranged at a second end of the lubricant channel.

Furthermore, the discharge device can either be formed by the end of the lubricant channel or have a flow device that shapes the flow of lubricant from the lubricant channel in order to ensure a targeted outflow at a location. In this regard, the flow device can be formed akin to the spout of a teapot.

Furthermore, the supply device can have a fastening device for fastening to a transmission housing. The fastening device can have a first fastening segment with a feed-through for a screw or a rivet. In this way, the supply device can be fastened to a transmission housing.

The first fastening segment can be arranged or formed on the at least one path segment or on a first or on a second path segment.

In this regard, the first fastening segment can extend a first side part of the lubricant channel. The first fastening segment thus protrudes beyond a first side part of the lubricant channel.

In addition, the first fastening segment can extend away from an open side of the lubricant channel and/or in the opposite direction to a second fastening segment of the fastening device so that the first side part of the lubricant channel is extended or the first fastening segment then protrudes beyond a first side part of the lubricant channel.

Furthermore, the supply device can have a fastening device for fastening to a transmission housing. The fastening device can have a second fastening segment with a projection for engagement in a bore or in a feed-through in a transmission housing. The second fastening segment and the projection can be used to prevent the supply device from rotating around the first fastening segment, for example.

In this regard, the second fastening segment can be arranged on the at least one path segment or on a first or second path segment of the lubricant channel.

Furthermore, the second fastening segment can extend a first side part of the lubricant channel. The second fastening segment thus protrudes beyond a first side part of the lubricant channel.

Also, the second fastening segment can extend away from a closed side of the lubricant channel and/or the second fastening segment can extend from a bottom part of the lubricant channel in the opposite direction to a first fastening segment of the fastening device.

The fastening segments extending in opposite directions, or the first and second fastening segments extending in opposite directions, can form an angle of between 125 and 145 degrees.

In addition, the supply device can have a fastening device for fastening to a transmission housing. In this regard, the fastening device can include a retaining clamp with which a second housing projection of a transmission housing can be clamped.

The retaining clamp can be arranged on the at least one path segment of the lubricant channel or on a first or on a second path segment of the lubricant channel.

The retaining clamp can also be designed such that, together with a bottom part of the lubricant channel, it surrounds a second housing projection of a transmission housing in order to fasten the supply device to a transmission housing in a releasably connectable manner.

In addition, the retaining clamp can extend along a first path segment of the lubricant channel. This ensures that the retaining clamp is long enough for a secure surrounding.

Furthermore, the supply device can have a fastening device for fastening to a transmission housing. In this regard, the fastening device can include a centering bolt which can engage in a bore of a transmission housing in order to fix the supply device in place locally.

The centering bolt can be arranged at a second end of the lubricant channel. This increases stability when mounted on transmission housing.

Furthermore, the centering bolt can have a pointed end and a pressure surface opposite thereto, with the aid of which the pointed end of the centering bolt can be pressed or pushed into a bore of a transmission housing.

A second aspect of the present disclosure includes a system for supplying lubricant to at least one rolling bearing and/or at least one gear in the interior of a transmission housing.

Reference is explicitly made to the fact that the features of the supply device, as mentioned under the first aspect, can be used in the system individually or in combination with one another.

In other words, the features mentioned above under the first aspect of the disclosure relating to the supply device can also be combined with further features described herein under the second aspect of the disclosure.

As such, the system for supplying lubricant to at least one rolling bearing and/or at least one gear in the interior of a transmission housing includes a first supply device according to the first aspect and a second supply device also according to the first aspect of the present disclosure. The system for supplying lubricant ensures that sufficient lubricating oil or lubricant is available for a rolling bearing or rotor shaft bearing both when the vehicle is traveling forwards and when it is traveling in reverse.

In this regard, the first supply device has a fastening device for fastening to a transmission housing, which includes a first fastening segment and/or a second fastening segment.

The second supply device also includes a fastening device for fastening to a transmission housing, which has a centering bolt and/or a retaining clamp.

This means that the two supply devices can be fastened to a transmission housing in order to supply, for example, a rolling bearing or a particular rotor shaft bearing in the interior of the transmission housing when the vehicle is traveling in reverse.

The two supply devices of the system can be arranged relative to one another within a transmission housing in such a manner that the discharge device of the first supply device is attached at the second end of the lubricant channel of the first supply device above the inflow device of the second supply device. This ensures a flow of lubricant from the first to the second supply device and on to a rolling bearing, for example.

The discharge device of the first supply device and the inflow device of the second supply device can also overlap so that lubricant can flow from the first into the second supply device or from the first lubricant channel into the second lubricant channel. Lubricant can also flow within each lubricant channel, as the lubricant channels or their bottom parts can have a slope.

A third aspect of the present disclosure includes a transmission for a vehicle with a lubricant supply in both directions of travel.

Reference is explicitly made to the fact that the features of the system, as mentioned under the second aspect, can be used in the transmission for a vehicle with a lubricant supply in both directions of travel, both individually or in combination with one another.

In other words, the features mentioned above under the second aspect of the disclosure relating to the system can also be combined with further features described herein under the third aspect of the disclosure.

The features of the supply device as mentioned under the first aspect can also be used in the transmission for a vehicle with a lubricant supply in both directions of travel, both individually or in combination with one another.

In other words, the features mentioned above under the first aspect of the disclosure relating to the supply device can also be combined with further features described herein under the third aspect of the disclosure.

The transmission for a vehicle with a lubricant supply in both directions of travel includes at least one system for supplying lubricant to at least one rolling bearing and/or at least one gear in the interior of a transmission housing according to the second aspect. The system for supplying lubricant ensures that sufficient lubricating oil or lubricant is available for a rolling bearing or rotor shaft bearing both when the vehicle is traveling forwards and when it is traveling in reverse.

In addition, the transmission can include a shifting device with a movable shifting element, such as a shift fork.

Furthermore, the transmission can include at least one rolling bearing for a shaft or for a hollow shaft, such as for a rotor shaft of an electric machine.

The transmission can also have a transmission housing which encloses at least the at least one rolling bearing and/or which supports the at least one rolling bearing. The transmission housing can support the at least one rolling bearing, as the rolling bearing can be inserted into the transmission housing. The transmission housing can be designed in multiple parts in order to facilitate the assembly of the transmission.

Furthermore, the supply devices of the system can be arranged on the transmission housing in such a manner that a flow of lubricant around the movable shifting element to the at least one rolling bearing can be ensured. Ideally, this applies to a reverse travel of a vehicle with the transmission, in which a transmission without a system for supplying lubricant to at least one rolling bearing and/or at least one gear in the interior of a transmission housing does not deliver sufficient lubricant to the rolling bearing.

The supply devices of the system can together form a U-shape, within which the movable shifting element is arranged. Thus, the shifting element can be moved or displaced linearly between the two legs of the U-shape without the shifting element and the system for supplying lubricant according to the second aspect contacting one another or interfering with one another. The two-part design of the system makes it possible, for example, to fasten the first supply device of the system to a first part of the transmission housing and the second supply device of the system to a second part of the transmission housing.

Furthermore, the transmission can have a support device for lateral guidance of an internal gear of a first partial transmission of the transmission. The support device can have a coupling body that can be pressed into the transmission housing of the transmission.

The coupling body can be designed to receive and displace a sliding sleeve of the shifting device. The coupling body can also have a toothing for a sliding sleeve of the shifting device, for example on the outside. This allows a flow of force to be established between the transmission housing and the internal gear. In other words, the rotation of the internal gear relative to the transmission housing can be blocked or released.

Furthermore, the transmission can have a support device for lateral guidance of an internal gear of a first partial transmission of the transmission. The support device can have a support plate that can be fastened to the transmission housing together with an internal gear of a second partial transmission of the transmission.

In addition, the support plate can be designed as an annular disc, similar to a shim or washer, for example with an S-shaped cross-section.

In addition, the support plate can have a toothing on the outside or on its radially outer side so that it can engage together with an outer toothing of an internal gear of a second partial transmission of the transmission in a mating toothing of the transmission housing.

The support plate and a coupling body of the support device of the transmission can also be arranged at a distance from one another so that an internal gear of a first partial transmission of the transmission can be arranged within the distance between the two.

Furthermore, the support plate can also serve to form a barrier for lubricant in order to provide a lubricant sump or to provide a certain level of lubricant in a certain transmission region.

The support plate can have a passage for the first supply device, for example for an inflow device of the first supply device, in order to guide or direct lubricant from one side of the support plate to the other side and into the lubricant channel.

The passage and the inflow device of the first supply device or a tubular segment of the inflow device can be arranged at a distance from one another so that movements of the support plate and the first supply device are decoupled from one another.

Furthermore, a fastening device of the first supply device can be attached to the transmission housing and/or to a support device of the transmission.

A first fastening segment of the fastening device of the first supply device can be fastened to the transmission housing by means of a screw or a rivet which is guided through a feed-through of the first fastening segment.

A projection of a second fastening segment of the fastening device of the first supply device can engage in a bore or in a feed-through of a support device of the transmission, which can be formed as a support plate, in order to prevent a displacement of the first supply device perpendicular to the bore or to the feed-through.

In addition, the transmission housing can have a first housing projection, against which a second end of the lubricant channel of the first supply device rests in a contacting manner in order to achieve a clamping of the second end in the direction of a second path segment of the lubricant channel and thus a fixation of the second path segment.

Furthermore, a fastening device of the second supply device can be attached to the transmission housing.

A centering bolt of the fastening device of the second supply device can engage in a bore of the transmission housing in order to fix or fasten the second supply device in place locally.

In addition, a fastening device of the second supply device can be attached to the transmission housing.

The transmission housing can have a second housing projection for the fastening device.

In this regard, a retaining clamp of the fastening device of the second supply device can clamp the second housing projection.

The retaining clamp can clamp the second housing projection together with a bottom part of the lubricant channel of the second supply device in order to fasten the second supply device to the transmission housing in a releasably connectable manner.

Furthermore, fastening devices of the supply devices of the system can be arranged on the transmission housing in such a manner that a first end of the lubricant channel of the first supply device is arranged higher than a second end of the lubricant channel of the second supply device so that a lubricant flow along the height difference between the two ends can be implemented.

In addition, the transmission can have an internal gear of a first partial transmission of the transmission, which can be guided between a coupling body of a support device of the transmission and a support plate of a support device of the transmission.

The shifting device can have the movable shifting element, such as a shift fork, a sliding sleeve and a shift actuator.

In this regard, the shift actuator can be designed to linearly move or displace the movable shifting element.

The movable shifting element can also be operatively connected to the sliding sleeve in order to displace it in such a manner that it connects or disconnects a coupling body of a support device of the transmission with/from the internal gear of a first partial transmission of the transmission.

The coupling body and the internal gear can each have a toothing for the sliding sleeve on the outside.

As already indicated, the transmission can have a first partial transmission and/or a second partial transmission and/or a third partial transmission.

The first partial transmission can be implemented as a planetary transmission. As such, this transmission can have a sun gear, multiple planetary gears or planets, a planet carrier and an internal gear.

The second partial transmission can also be implemented as a planetary transmission. As such, this transmission can have a sun gear, multiple planetary gears or planets, a planet carrier and an internal gear.

In this regard, the planet carrier of the first partial transmission can be operatively connected to the sun gear of the second partial transmission so that a torque and a speed can be passed on.

The third partial transmission can be designed as a planetary transmission and/or a Ravigneaux set. In this regard, the third partial transmission can convert a torque and a speed from the second partial transmission and pass these on to a shaft of the transmission.

A fourth aspect of the present disclosure includes a planetary gear transmission, in particular for a vehicle, or a transmission.

Reference is explicitly made to the fact that the features of the supply device, as mentioned under the first aspect, can be used individually or in combination with one another in the planetary gear transmission. The same applies to the features of the system according to the second aspect and to the features of the transmission according to the third aspect.

In other words, the features mentioned above under the first aspect of the disclosure relating to the supply device, the features mentioned above under the second aspect of the disclosure relating to the system and the features mentioned above under the third aspect of the disclosure relating to the transmission can also be combined with further features described herein under the fourth aspect of the disclosure.

Thus, the planetary gear transmission, in particular for a vehicle, or the transmission can include at least two internal gears arranged in different planes, of which the first internal gear is designed for meshing with a planetary gear of a first planetary gear set or of a first partial transmission and the second internal gear is designed for meshing with a planetary gear of a second planetary gear set or of a second partial transmission.

A support disc or a support plate of a support device can be arranged axially between the two internal gears and the first and/or the second planetary gear set or the first and/or the second partial transmission can be arranged on a rotor shaft or around a shaft and the rotor shaft can be supported in a rotor shaft bearing.

In this planetary gear transmission or transmission, a device for supplying lubricating oil or lubricant to the rotor shaft bearing can be fixed to a housing and/or non-rotating components.

The device for supplying lubricating oil to the rotor shaft bearing on a housing can also be referred to as a system for supplying lubricant to at least one rolling bearing and/or at least one gear in the interior of a transmission housing. In this regard, the system can have two supply devices for supplying lubricant to at least one rolling bearing and/or at least one gear in a transmission housing.

The device for supplying lubricating oil to the rotor shaft bearing ensures that sufficient lubricating oil is available for the rotor shaft bearing both when the vehicle is traveling forwards and when it is traveling in reverse. This ensures the operational capability of the planetary gear transmission or the first and/or second partial transmission or the rotor shaft or shaft no matter which gear is engaged.

The device for supplying lubricating oil to the rotor shaft bearing can collect the lubricating oil ejected from the oil sump by the planetary gears of the planetary gear sets and direct it to the rotor shaft bearing or rolling bearing in a targeted manner, where it is lubricated directly. As the rotor shaft bearing or the first and/or second partial transmission can experience high speeds, there is always sufficient lubricating oil available to cool the rotor shaft bearing. There is therefore no need for a structural alignment of the gears and the rotor shaft bearing in order to adjust the pumping direction for the lubricating oil in a targeted manner.

According to one embodiment, the system with its two supply devices or the device for supplying lubricating oil/lubricant to the rotor shaft bearing or the rolling bearing can be designed to be open at the top for collecting lubricating oil swirled up from an oil sump/transmission sump by the rotary movement of the planetary gear sets and can be designed to slope downwards in its axial extension towards the rotor shaft bearing or rolling bearing. In this regard, the system or a supply device for supplying lubricant to a rolling bearing in a transmission housing or the device can have a discharge device or an outlet which can be located directly opposite the rotor shaft bearing or rolling bearing for lubricating the rotor shaft bearing or for lubricating the rolling bearing. Due to the open design of the system or the device for supplying the rotor shaft bearing, the lubricating oil swirled up in the interior of the housing settles in the device and, due to the axial inclination of the device, is directed to the rotor shaft bearing without any further aids, onto which the collected lubricating oil then drips. Due to the axial dimensioning of the device for supplying lubricating oil to the rotor shaft bearing, sufficient lubricating oil can always be provided for lubricating the rotor shaft bearing.

According to a further embodiment, the system/device for supplying lubricating oil/lubricant to the rotor shaft bearing/rolling bearing can be designed in at least two parts or the system can be designed with two supply devices, wherein the two parts of the device or system overlap in an overflow region. The at least two-part design of the device/system makes it possible to circumvent, for example, the shift fork required for engaging the gears without taking up additional installation space. The functionality of the system or the device for supplying lubricating oil to the rotor shaft bearing is ensured at all times.

According to a further embodiment, the two supply devices of the system or the at least two parts of the device for supplying lubricating oil to the rotor shaft bearing can be arranged offset in height relative to one another. This allows for an even better utilization of the installation space available in the interior of the planetary gear transmission/transmission.

According to a further embodiment, a first supply device of the system or a first part of the device for supplying lubricating oil to the rotor shaft bearing or rolling bearing can, on the one hand, be held on the transmission housing by means of a force-fitting connection and, on the other hand, be clamped axially to an outflow or discharge device against a first rib-like projection of the housing or the transmission housing. This arrangement ensures that the first supply device of the system or the first part is secured against slipping and twisting in all three spatial directions, even at high speeds applied to the transmission. The axial mounting of the first supply device of the system or the first part of the device by means of the outflow/by means of the discharge device on the housing or on the transmission housing ensures that the system or the device cannot perform any large movements or vibrations during operation of the planetary gear transmission/transmission.

According to a further embodiment, the first supply device of the system or the first part of the device for supplying lubricating oil to the rotor shaft bearing can be secured to the support disc or to the support plate by means of a centering element and an oil pipe or an inflow device can be guided through a window of the support disc or through a feed-through of the support plate, wherein the oil pipe can be arranged in the window or in the feed-through at a distance from the support disc/support plate. This means that the system or device for supplying the rotor shaft bearing can be positioned in a fixed manner, although a distance between the oil pipe and support disc or between the inflow device and support plate can be ensured. The distance is necessary so that the support disc/support plate can deform and move slightly during operation of the planetary gear transmission. In this manner, axial forces for the internal gears axially connected to the support disc/support plate can be provided by the support disc/support plate.

In a further embodiment, the second supply device of the system or the second part of the device for supplying lubricating oil to the rotor shaft bearing can have a cast-on radially extending centering bolt for fastening to a motor housing or to a transmission housing, wherein the surface arranged opposite the motor housing/transmission housing or the surface facing away or pressure surface, for example a wall of the second part, can be held in place by means of a further component. This reliably prevents an axial movement of the second supply device of the system or the second part of the device for supplying lubricating oil to the rotor shaft bearing.

In a further embodiment, the second supply device of the system or the second part of the device for supplying lubricating oil to the rotor shaft bearing can have a retaining lip or a retaining clamp for receiving a rib-like projection formed on the housing/transmission housing or a second housing projection of the transmission housing. The second part of the device or the second supply device is protected against twisting by the retaining lip/retaining clamp engaging on the rib-like projection.

In a further embodiment, the second supply device of the system or the second part of the device for supplying lubricating oil to the rotor shaft bearing can rest with a longitudinal extension on a surface of the housing or the transmission housing. This allows the device/the system to be additionally secured against twisting and slipping.

In a further embodiment, the system or the device for supplying lubricating oil to the rotor shaft bearing can be made of plastic. Plastic devices can be mass-produced in large quantities and at low cost. In addition, the device for supplying lubricating oil to the rotor shaft bearing made of plastic helps to reduce the weight of the planetary gear transmission or transmission and thus also to reduce the weight of the vehicle in which the planetary gear transmission is installed.

This disclosure concerns—in simplified terms—an ordinary transmission. In a conventional vehicle, the transmission is designed in such a manner that the lubrication functions when the vehicle is traveling forwards. Traveling in reverse, due to the low amounts of time a vehicle spends reversing, only plays a very small role here and is often not considered to a significant extent in the lubrication setup of the transmission, as the transmission cannot be damaged in the short time of a normal reverse travel due to the low loads and little time spent reversing. As such, the pumping direction of the gears and the bearings is designed in such a manner that they deliver the oil or lubricant to the correct or wear-critical point.

Due to the fact that a robot taxi, for example, performs the same amount of driving in both directions in regular driving operation, the oiling/lubrication of the transmission when the vehicle is traveling in reverse can be considered critical if no additional measures are adopted. This is because the pumping effect of the gears is counterproductive due to the reverse direction of rotation.

The oil or lubricant is consequently pumped away from a rotor bearing or rolling bearing. The rotary movement of the planetary gear set can cause some of the oil/lubricant to be thrown up from an oil sump.

The oil that is thrown up can be collected and guided past an input stage gear set of a first partial transmission of the transmission and an associated shift fork by means of so-called oil slides or supply devices so that the rotor bearing can be lubricated directly. The oil slides or supply devices are retained in the non-rotating components and in the transmission housings. The oil or lubricant can be fed from the oil slides into the specially designed channels on the rotor shaft bearing or rolling bearing, from which the rotor shaft bearing can be lubricated.

Because the oil slide can be mounted between two housing halves of a transmission housing and can circumvent a shift fork, the oil slide can have a total of two components or two supply devices, which can be mounted individually in the respective housing halves.

The assembly is carried out in such a manner that the oil slides or supply devices of the system can be secured against slipping and twisting in all three spatial directions. In addition, the oil slides can be positioned such as to ensure that these parts function properly. The geometry of the oil slides or supply devices can also be designed in such a manner that they can be mass-produced from plastic in a manner that is both simple and easily implemented.

An oil slide or supply device can be screwed to the housing using a screw. In order to prevent it from twisting, it can additionally be held in a support plate using a projecting centering pin. This ensures an adequate positioning of the oil pipe, which can penetrate the support plate.

An oil slide or supply device can be held axially by means of an end face on a rib of the transmission housing. This is necessary so that the oil slide cannot move or vibrate too much during operation due to its low rigidity.

A distance can be maintained between the support plate and the oil pipe, which extends through the windows of the support plate so that the support plate can deform and move slightly during operation. The screw connection can be made using a compression limiter in order to prevent the plastic from clamping together while tightening the screw on the block.

Furthermore, an oil slide or supply device can be fastened in the transmission housing by means of a cast-on centering bolt. The bolt can be inserted into a bore. On the flat end face of this bolt on the other side of the oil slide or supply device, it can be held in place by means of a sliding sleeve carrier inserted in the transmission or by means of a shifting element, such as a shift fork, in order to prevent an axial movement of the oil slide. The oil slide or supply device can be fastened to a rib cast onto the transmission housing and secured against twisting by means of a retaining lip or retaining clamp. Axially, in order to avoid vibrations and deformations, the oil slide can be held in place by a flat surface in the transmission housing.

### BRIEF DESCRIPTION OF THE DRAWINGS

The disclosure is explained in more detail below with reference to exemplary embodiments in conjunction with associated drawings. In the schematic drawings:

FIGS. 1 to 3 show two spatial views of a supply device according to a first exemplary embodiment as well as an enlargement of a partial region of the supply device and schematic representations of a first part of the device for supplying lubricating oil to a rotor shaft bearing according to FIG. 19;

FIGS. 4 to 6 show two spatial views of a supply device according to a second exemplary embodiment as well as an enlargement of a partial region of the supply device and schematic representations of a second part of the device for supplying lubricating oil to a rotor shaft bearing according to FIG. 19;

FIG. 7 shows a spatial view of a system for supplying lubricant to a rolling bearing in the interior of a transmission housing;

FIG. 8 shows the system from FIG. 7 on a transmission housing;

FIGS. 9A, 9B show one and the same transmission for a vehicle with a system from FIGS. 7 and 8, but with the difference that, for the sake of clarity, sections and reference signs are separated in FIGS. 9A and 9B;

FIG. 10 again shows the system from FIG. 8 on a transmission housing, but shown in section or along the line F-F from FIG. 9;

FIG. 11 shows an enlarged view of the circled region X from FIG. 9;

FIG. 12 shows the view from FIG. 11, but with the viewing direction downwards to the right towards a shift sleeve;

FIG. 13 shows the view from FIG. 11, but compared to FIG. 12 with the viewing direction towards the top left;

FIG. 14 shows a sectional view along the line A-A from FIG. 9;

FIG. 15 shows a sectional view along the line B-B from FIG. 9;

FIG. 16 shows a sectional view along the line C-C from FIG. 9;

FIG. 17 shows a sectional view along the line D-D from FIG. 9;

FIG. 18 shows an exemplary embodiment of the planetary gear transmission according to the disclosure;

FIG. 19 shows an exemplary embodiment of the device for supplying lubricating oil to a rotor shaft bearing,

FIG. 20 shows various perspective views of the first part of the device for supplying lubricating oil to a rotor shaft bearing installed in the planetary gear transmission; and

FIG. 21 shows various perspective views of the second part of the device for supplying lubricating oil to a rotor shaft bearing installed in the planetary gear transmission.

### DETAILED DESCRIPTION

In the description below, the same reference signs are used for the same components.

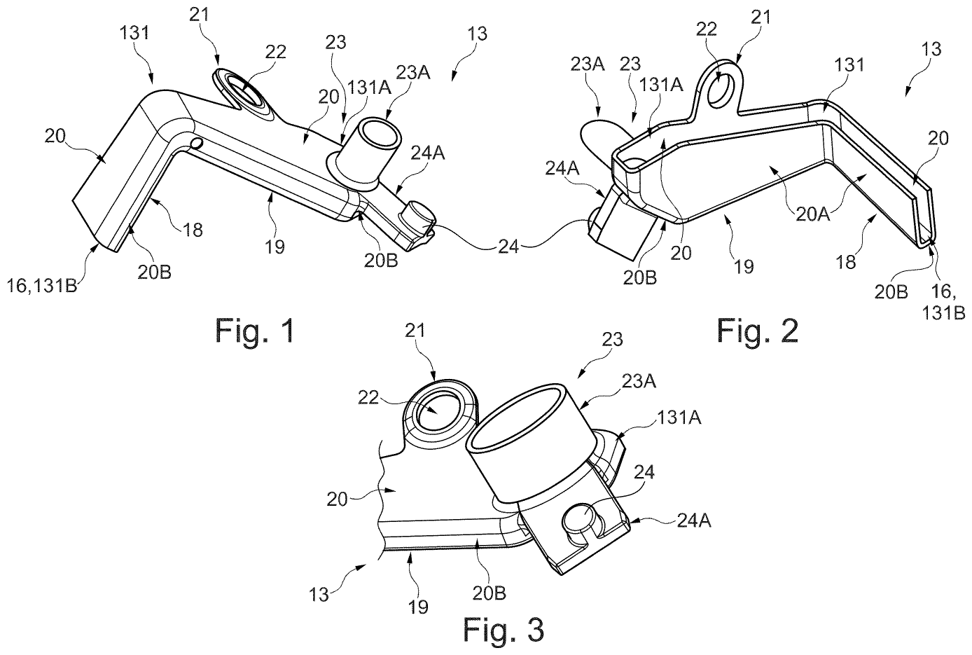

FIGS. 1 to 3 show two spatial views of a supply device 13 according to a first exemplary embodiment as well as an enlargement of a partial region of the supply device 13 (FIG. 3).

For the sake of simplicity and brevity, FIGS. 1 to 3 are described together below.

As such, said figures show a supply device 13 for supplying lubricant to a rolling bearing 8 (not shown) and/or at least one gear in a transmission housing 11 (not shown).

According to FIGS. 1 to 3, the supply device 13 has a lubricant channel 131 with two path segments 18, 19.

The two path segments 18, 19 are arranged at an angle to one another in order to circumvent an obstacle, such as a planetary transmission 1A or a shifting device 17, 40 (not shown) for shifting gears of a transmission 1 (not shown), within a transmission housing 11. In this way, lubricant can also be collected at a position with sufficient lubricant during reverse travel, for example, in which lubricant is conveyed away from a bearing to be lubricated (for example due to the pumping effect of a helical toothing), and guided or directed to a bearing to be lubricated or to a gear to be lubricated or to a gear pairing to be lubricated.

More specifically, the lubricant channel 131 has a first path segment 19 and a second path segment 18, wherein the first path segment 19 and the second path segment 18 are connected to one another.

The first path segment 19 and the second path segment 18 form an angle of 90 degrees to one another. In other words, the first path segment 19 and the second path segment 18 together form an L-shape.

In this regard, the lubricant channel 131 is designed such that lubricant filled into the lubricant channel 131 flows from a first end 131A of the lubricant channel 131 to a second end 131B of the lubricant channel 131.

Thus, as mentioned, according to FIGS. 1 to 3, the lubricant channel 131 has a first end 131A and a second end 131B, wherein the first path segment 19 includes the first end 131A and the second path segment 18 includes the second end 131B.

Furthermore, FIGS. 1 to 3 show that the lubricant channel 131 has an open side for the inflow of lubricant and a closed side, which is formed by a bottom part 20B of the lubricant channel 131.

In this regard, the lubricant channel 131 is designed akin to a roof gutter or playground slide and has-as already indicated-a bottom part 20B, a first and a second side part 20, 20A which together form a U-shaped cross-section.

In order for lubricant to flow along the lubricant channel 131 from its first end 131A to its second end 131B, the lubricant channel 131 or its bottom part 20B includes a slope.

Furthermore, FIGS. 1 to 3 show that the supply device 13 has an inflow device 23 and a discharge device 16 for receiving lubricant at one location and discharging it at another location.

The inflow device 23 is arranged at the first end 131A of the lubricant channel 131. Here, the inflow device 23 includes the first path segment 19 and a tubular or a generally cylindrical segment 23A through which lubricant can flow.

The tubular segment 23A of the inflow device 23 opens into the first path segment 19 in order to additionally supply it with lubricant. In this regard, the inflow device 23 or the tubular segment 23A is arranged on the first side part 20 of the lubricant channel 131 and connected thereto in a fluid-communicating manner.

The discharge device 16 is arranged at a second end 131B of the lubricant channel 131, and can either be formed by the end of the lubricant channel 131 or have a flow device (not shown) that shapes the flow of lubricant from the lubricant channel 131 in order to ensure a targeted outflow at a location.

Furthermore, FIGS. 1 to 3 show that the supply device 13 has a fastening device 21, 22; 24A, 24 for fastening to a transmission housing 11.

The fastening device 21, 22; 24A, 24 includes a first fastening segment 21 with a feed-through 22 for a screw or for a rivet. Thus, the supply device 13 can be fastened to a transmission housing 11.

The first fastening segment 21 is arranged on the first path segment 19 and extends the first side part 20 of the lubricant channel 131.

In this regard, the first fastening segment 21 extends away from an open side of the lubricant channel 131 or in the opposite direction to a second fastening segment 24A of the fastening device 21, 22; 24A, 24 so that the first side part 20 of the lubricant channel 131 is extended.

As can be seen in FIGS. 1 to 3, the fastening device 21, 22; 24A, 24 further has a second fastening segment 24A with a projection 24 for engagement in a bore or in a feed-through in a transmission housing 11. The second fastening segment 24A and the projection 24 can be used to prevent the supply device 13 from rotating around the first fastening segment 21, for example.

The second fastening segment 24A is arranged on the first path segment 19 of the lubricant channel 131 and extends the first side part 20 of the lubricant channel 131.

In other words, the second fastening segment 24A extends away from a closed side of the lubricant channel 131 or the second fastening segment 24A extends away from the bottom part 20B of the lubricant channel 131 or in the opposite direction to the first fastening segment 21 of the fastening device 21, 22; 24A, 24. Strictly speaking, the fastening segments 21, 24A extending in opposite directions form an angle of between 125 and 145 degrees.

Finally, it should also be mentioned that the lubricant channel 131 is formed integrally or in one piece and is made of plastic.

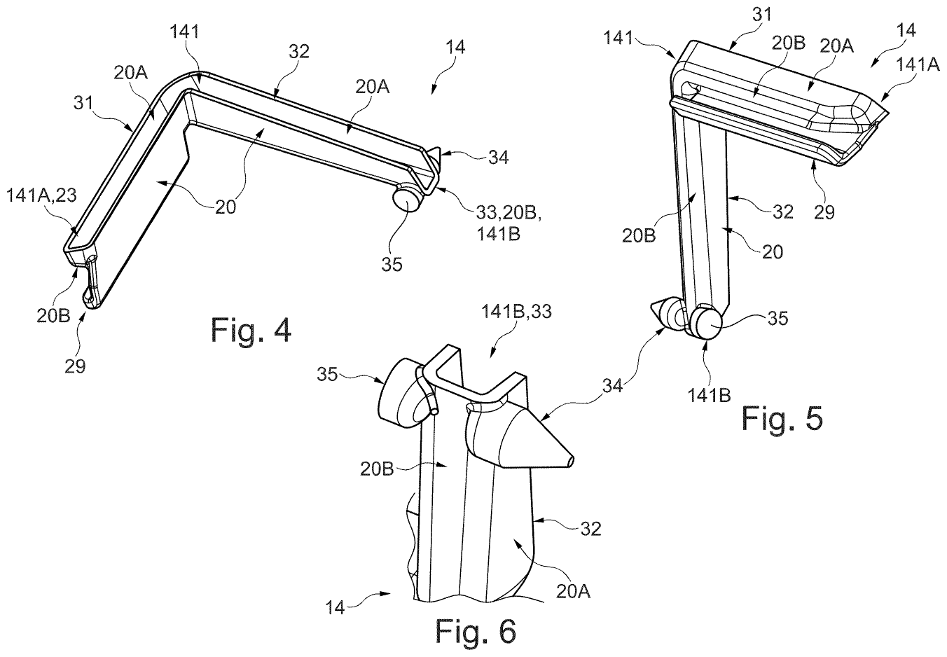

FIGS. 4 to 6 show two spatial views of a supply device 14 according to a second exemplary embodiment as well as an enlargement of a partial region of the supply device 14 (FIG. 6).

For the sake of simplicity and brevity, FIGS. 4 to 6 are described together below.

As such, said Figures show a supply device 14 for supplying lubricant to a rolling bearing 8 (not shown) and/or at least one gear in a transmission housing 11 (not shown).

Here, the supply device 14 has a lubricant channel 141 with two path segments 31, 32 arranged at an angle to one another in order to circumvent an obstacle, such as a planetary transmission 1A or a shifting device 17, 40 (not shown) for shifting gears of a transmission 1 (not shown), within a transmission housing 11. In this way, lubricant can also be collected at a position with sufficient lubricant during reverse travel, for example, in which lubricant is conveyed away from a bearing to be lubricated (for example due to the pumping effect of a helical toothing), and guided or directed to a bearing to be lubricated or to a gear to be lubricated or to a gear pairing to be lubricated.

More specifically, the lubricant channel 141 has a first path segment 31 and a second path segment 32, which are connected to one another.

The first path segment 31 and the second path segment 32 form an angle of 90 degrees to one another. In other words, the first path segment 31 and the second path segment 32 together form an L-shape.

In addition, the lubricant channel 141 is designed such that lubricant filled into the lubricant channel 141 flows from a first end 141A of the lubricant channel 141 to a second end 141B of the lubricant channel 141.

Thus, as mentioned above, the lubricant channel 141 has a first end 141A and a second end 141B, wherein the first path segment 31 includes the first end 141A and the second path segment 32 includes the second end 141B.

Furthermore, according to FIGS. 4 to 6, the lubricant channel 141 has an open side for the inflow of lubricant and a closed side, which is formed by a bottom part 20B of the lubricant channel 141.

As can be seen in FIGS. 4 to 6, the lubricant channel 141 is designed akin to a roof gutter or playground slide. In this regard, the lubricant channel 141 has a bottom part 20B, a first and a second side part 20, 20A which together form a U-shaped cross-section.

Furthermore, the lubricant channel 141 or its bottom part 20B has a slope so that lubricant can flow along the lubricant channel 141 from the first end 141A of the lubricant channel 141 to the second end 141B.

In addition, FIGS. 4 to 6 show that the supply device 14 has an inflow device 23 and a discharge device 33 for receiving lubricant at one location and discharging it at another location.

The inflow device 23 has the first path segment 19 of the lubricant channel 141.

The discharge device 33, on the other hand, is arranged at the second end 141B of the lubricant channel 141. Here, the discharge device 33 can either be formed by the end of the lubricant channel 141 or has a flow device (not shown) that shapes the flow of lubricant from the lubricant channel 141 in order to ensure a targeted outflow at a location.

Furthermore, FIGS. 4 to 6 show that the supply device 14 has a fastening device 29; 34, 35 for fastening to a transmission housing 11.

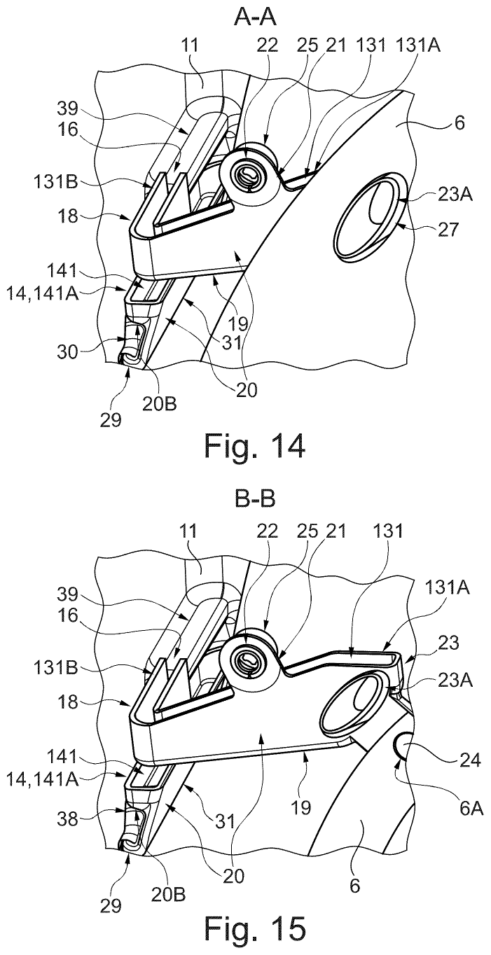

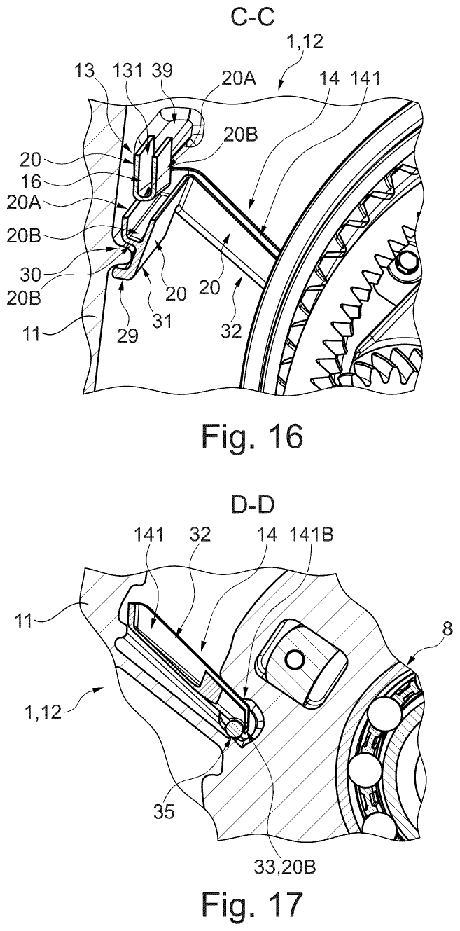

In this regard, the fastening device 29; 34, 35 has a retaining clamp 29 with which a second housing projection 30 (not shown or cf. FIGS. 14, 15, 16 and 20) of a transmission housing 11 can be clamped.

The retaining clamp 29 is arranged on the first path segment 31 of the lubricant channel 141. The retaining clamp 29 is designed such that, together with the bottom part 20B of the lubricant channel 141, it surrounds a second housing projection 30 of a transmission housing 11 in order to fasten the supply device 14 to a transmission housing 11 in a releasably connectable manner.

The retaining clamp 29 extends along the first path segment 31 of the lubricant channel 141.

Furthermore, the fastening device 29; 34, 35 has a centering bolt 34 which can engage in a bore of a transmission housing 11 in order to fix the supply device 14 in place locally.

As shown in FIGS. 4 to 6, the centering bolt 34 is arranged at the second end 141B of the lubricant channel 141. In this regard, the centering bolt 34 has a pointed end and a pressure surface 35 opposite thereto, with the aid of which the pointed end of the centering bolt 34 can be pressed into a bore of a transmission housing 11.

Finally, it should also be mentioned that the lubricant channel 141 is formed integrally or in one piece and is made of plastic.

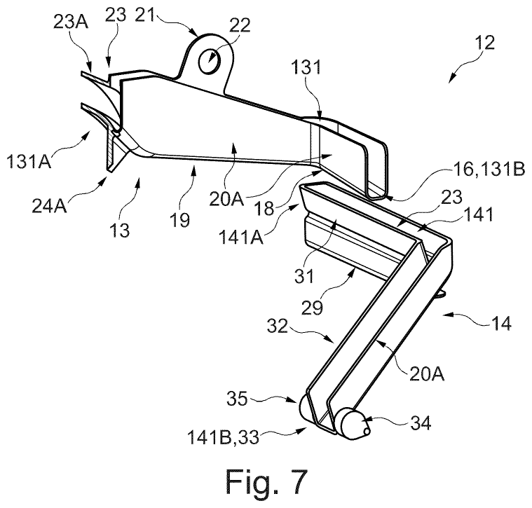

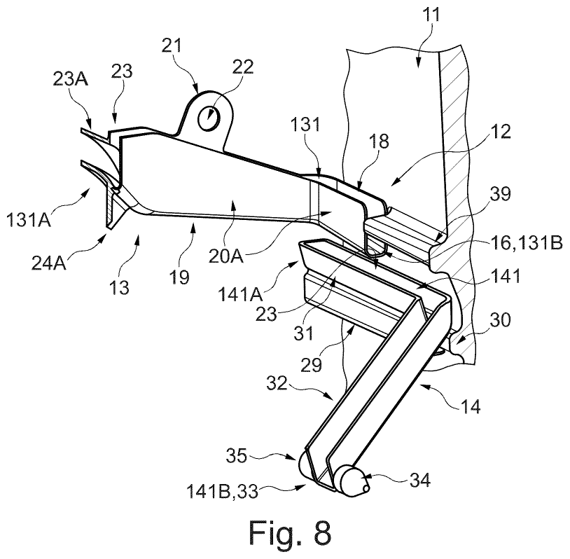

FIG. 7 shows a spatial view of a system 12 for supplying lubricant to a rolling bearing 8 (not shown) in the interior of a transmission housing 11, wherein only FIG. 8 shows the system 12 from FIG. 7 on a transmission housing 11.

As such, FIGS. 7 and 8 show a system 12 for supplying lubricant to a rolling bearing 8 in the interior of a transmission housing 11, which includes a first supply device 13 according to FIGS. 1 to 3 and a second supply device 14 according to FIGS. 4 to 6.

As already explained with respect to FIGS. 1 to 3, the first supply device 13 has a fastening device 21, 22; 24A, 24 for fastening to a transmission housing 11. In this regard, the fastening device 21, 22; 24A, 24 has a first fastening segment 21 and a second fastening segment 24A. The second fastening segment 24A is only indicated in the figure due to the sectional view.

For further explanations concerning the first supply device 13, reference is made to the description of FIGS. 1 to 3.

It has also already been explained with regard to FIGS. 4 to 6 that the second supply device 14 has a fastening device 29; 34, 35 for fastening to a transmission housing 11. In this regard, the fastening device 29; 34, 35 includes a centering bolt 34 and a retaining clamp 29.

Here too, reference is made to the description of FIGS. 4 to 6 for further explanations concerning the second supply device 14.

As can be seen with reference to FIGS. 7 and 8, the two supply devices 13, 14 of the system 12 are arranged relative to one another within a transmission housing 11 in such a manner that the discharge device 16 of the first supply device 13 is attached at the second end 131B of the lubricant channel 131 of the first supply device 13 above the inflow device 23 of the second supply device 14.

Thus, the discharge device 16 of the first supply device 13 and the inflow device 23 of the second supply device 14 overlap so that lubricant can flow from the first supply device 13 into the second supply device 14 or from the first lubricant channel 131 into the second lubricant channel 141. Lubricant can also flow within each lubricant channel 131, 141, as the lubricant channels 131, 141 or their bottom parts 20B have a slope.

In order to supply the lubricant channel 131 of the first supply device 13 with sufficient lubricant, the first supply device 13 has the inflow device 23 with its tubular section 23A, which is shown in a sectional view.

This makes clear that the tubular segment 23A of the inflow device 23 opens into the first path segment 19 in order to supply it with lubricant. In other words, the inflow device 23 or the tubular segment 23A has the task of collecting lubricant from another region of a transmission (not shown) where sufficient lubricant is available and directing it into the lubricant channel 131. This means that lubricant can be received at one location and discharged at another.

FIG. 8 also shows-as already mentioned-a transmission housing 11 with a first housing projection 39, against which a second end 131B of the lubricant channel 131 of the first supply device 13 rests in a contacting manner in order to achieve a clamping of the second end 131B in the direction of the second path segment 18 of the lubricant channel 131 and thus a fixation of the second path segment 18.

Furthermore, FIG. 8 shows that the fastening device 29; 34, 35 of the second supply device 14 is attached to the transmission housing 11.

In this regard, the transmission housing 11 has a second housing projection 30 for the fastening device 29; 34, 35, wherein the retaining clamp 29 of the fastening device 29; 34, 35 of the second supply device 14 clamps the second housing projection 30.

Strictly speaking, the retaining clamp 29 clamps the second housing projection 30 together with the bottom part 20C of the lubricant channel 141 of the second supply device 14 in order to fasten the second supply device 14 to the transmission housing 11 in a releasably connectable manner.

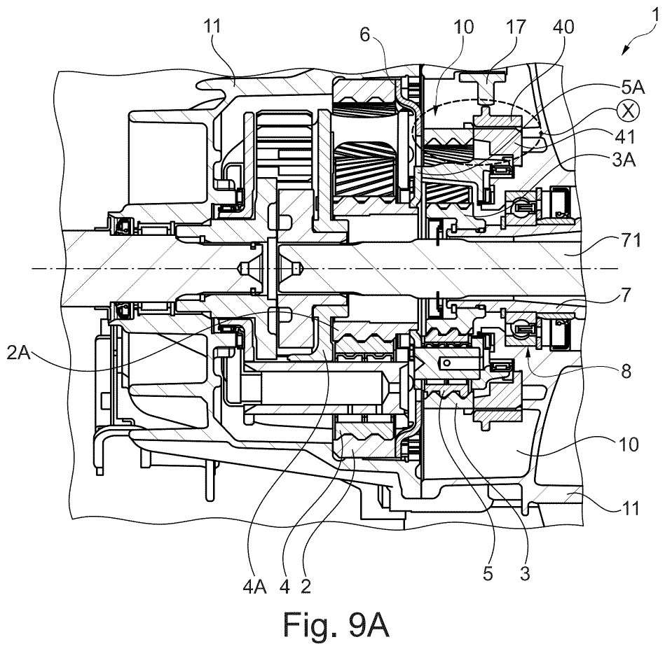

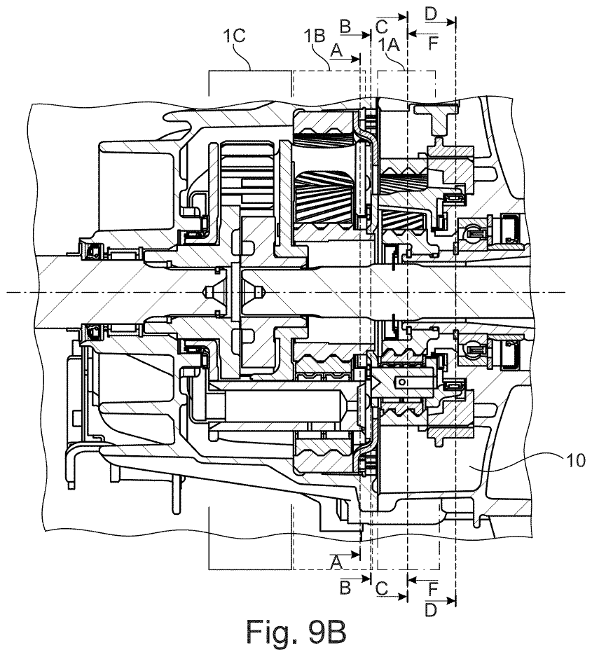

FIGS. 9A and 9B show one and the same transmission 1 for a vehicle with a system 12 from FIGS. 7 and 8, but with the difference that, for the sake of clarity, sections and reference signs are separated in FIGS. 9A and 9B.

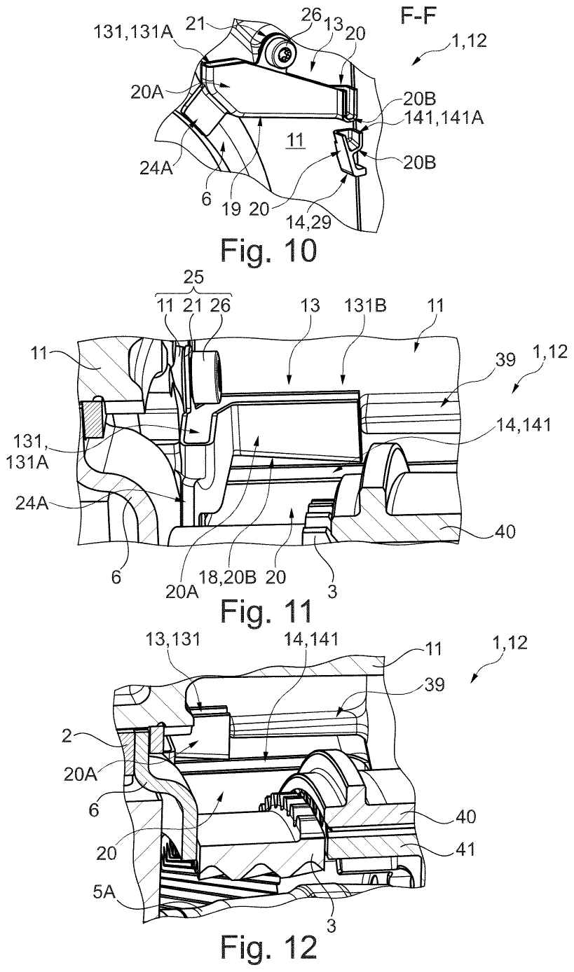

FIG. 10 again shows the system 12 from FIG. 8 on a transmission housing 11, but shown in section or along the line F-F from FIG. 9B, wherein FIG. 11 shows an enlarged view of the circled region X from FIG. 9A.

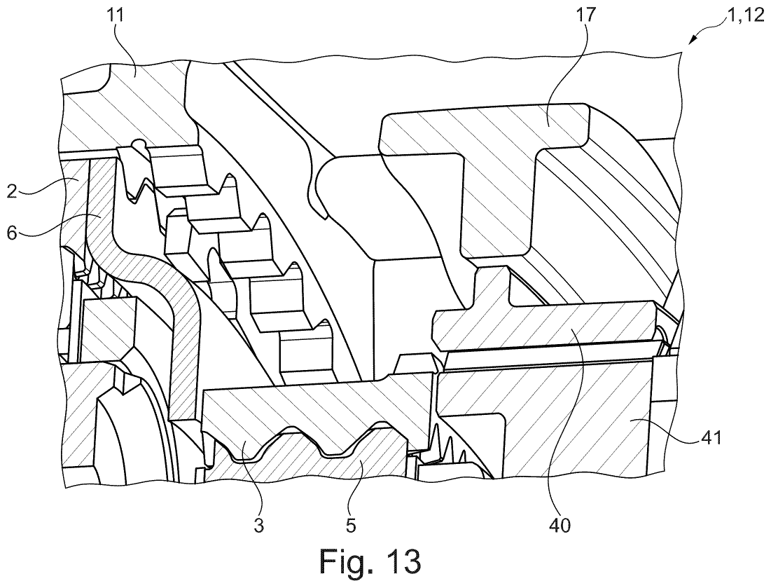

FIG. 12 shows the view from FIG. 11, but with the viewing direction downwards to the right towards a shift sleeve 40, whereas FIG. 13 shows the view from FIG. 11, but with the viewing direction towards the top left compared to FIG. 12.

FIGS. 14 to 17 show sectional views along the lines A-A, B-B, C-C and D-D from FIG. 9B.

FIGS. 9A, 9B to 17 thus show a transmission 1 for a vehicle, which includes a system 12 for supplying lubricant to a rolling bearing 8, a shifting device 17, 40 with a movable shifting element 17, such as a shift fork, a rolling bearing 8 for a shaft 7 or for a hollow shaft 7, such as for a rotor shaft of an electric machine, and a transmission housing 11. The transmission housing 11 encloses at least the rolling bearing 8 and/or supports the rolling bearing 8.

The supply devices 13, 14 of the system 12 are arranged on the transmission housing 11 in such a manner that a flow of lubricant around the movable shifting element 17 to the rolling bearing 8 can be ensured.

As can be seen in FIGS. 14 to 17, the supply devices 13, 14 of the system 12 together form a U-shape, within which the movable shifting element 17 is arranged (cf. FIGS. 7 and 8).

According to FIGS. 9A to 15, the transmission 1 has a support device 6, 41 for lateral guidance of an internal gear 3 of a first partial transmission 1A of the transmission 1 (cf. FIGS. 9A and 9B).

In this regard, the support device 6, 41 has a coupling body 41 which is pressed into the transmission housing 11, wherein the coupling body 41 is designed to receive and displace a sliding sleeve 40 of the shifting device 17, 40.

Furthermore, FIGS. 9A, 9B, 12 and 13 show that the coupling body 41 has a toothing on the outside for the sliding sleeve 40 of the shifting device 17, 40.

Furthermore, the support device 6, 41 includes a support plate 6, which is fastened to the transmission housing 11 together with an internal gear 2 of a second partial transmission 1B of the transmission 1 (cf. FIGS. 9A, 12 and 13). In this regard, the support plate 6 is designed as an annular disc, similar to a shim or washer, but with an S-shaped cross-section (cf. FIG. 13).

According to FIG. 13, the support plate 6 has a toothing on the outside or on its radially outer side so that it can engage together with an outer toothing of the internal gear 2 of a second partial transmission 1B of the transmission 1 in a mating toothing of the transmission housing 11 (cf. FIG. 13).

As shown in FIGS. 9A, 9B, 10 to 13, the support plate 6 and the coupling body 41 of the support device 6, 41 of the transmission 1 are arranged at a distance from one another so that an internal gear 3 of a first partial transmission 1A of the transmission 1 can be arranged within the distance between the two.

According to FIGS. 9A and 9B, the support plate 6 serves to form a barrier for lubricant in order to provide a lubricant sump 10 or to provide a certain level of lubricant in a certain transmission region.

FIG. 14 shows that the support plate 6 has a passage 27 for the first supply device 13 or for the inflow device 23 of the first supply device 13 in order to guide lubricant from one side of the support plate 6 to the other side and into the lubricant channel 131 (cf. FIG. 15).

The passage 27 and the inflow device 23 of the first supply device 13 or the tubular segment 23A of the inflow device 23 are arranged at a distance from one another (cf. FIG. 14) so that movements of the support plate 6 and the first supply device 13 are decoupled from one another.

FIGS. 10 and 11 show that the fastening device 21, 22; 24A, 24 of the first supply device 13 is attached to the transmission housing 11 and to the support device 6, 41 of the transmission 1.

More specifically, the first fastening segment 21 of the fastening device 21, 22; 24A, 24 of the first supply device 13 is fastened to the transmission housing 11 by means of a screw 26 which is guided through the feed-through 22 of the first fastening segment 21.

The projection 24 of the second fastening segment 24A of the fastening device 21, 22; 24A, 24 of the first supply device 13 engages in a bore 6A or in a feed-through 6A of the support plate 6 (cf. FIG. 15) in order to prevent a displacement of the first supply device 13 perpendicular to the bore 6A or to the feed-through 6A.

As already indicated, the transmission housing 11 has a first housing projection 39, against which a second end 131B of the lubricant channel 131 of the first supply device 13 rests in a contacting manner in order to achieve a clamping of the second end 131B in the direction of a second path segment 18 of the lubricant channel 131 and thus a fixation of the second path segment 18 (cf. FIGS. 11, 12, 14, 15, 16).

Furthermore, according to FIGS. 14 to 17, a fastening device 29; 34, 35 of the second supply device 14 is attached to the transmission housing 11.

A centering bolt 34 of the fastening device 29; 34, 35 of the second supply device 14 engages in a bore of the transmission housing 11 in order to fix the second supply device 14 in place locally (cf. FIG. 17).

Furthermore-as likewise already mentioned-the transmission housing 11 has a second housing projection 30 for the fastening device 29; 34, 35. Here, a retaining clamp 29 of the fastening device 29; 34, 35 of the second supply device 14 clamps the second housing projection 30.

Furthermore, the retaining clamp 29 clamps the second housing projection 30 together with the bottom part 20C of the lubricant channel 141 of the second supply device 14 in order to fasten the second supply device 14 to the transmission housing 11 in a releasably connectable manner (cf. FIGS. 14 to 17).

As a result, it can be seen from FIGS. 10 to 12 and 14 to 16 that the fastening devices 21, 22; 24A, 24; 29; 34, 35 of the supply devices 13, 14 of the system 12 are arranged on the transmission housing 11 in such a manner that a first end 131A of the lubricant channel 131 of the first supply device 13 is arranged higher than a second end 141B of the lubricant channel 141 of the second supply device 14. This allows for a lubricant flow along the height difference between the two ends 131A, 141B.

As already explained, the transmission 1 has an internal gear 3 of a first partial transmission 1A of the transmission 1, which can be guided between the coupling body 41 and the support plate 6 of the support device 6, 41 of the transmission 1.

According to FIGS. 9A, 9B, 11, 12 and 13, the shifting device 17, 40 has the movable shifting element 17, such as a shift fork, a sliding sleeve 40 and a shift actuator (not shown).

The shift actuator is designed to linearly move the movable shifting element 17. Furthermore, the movable shifting element 17 is operatively connected to the sliding sleeve 40 in order to displace it in such a manner that it can connect or disconnect the coupling body 41 of the support device 6, 41 of the transmission 1 with/from the internal gear 3 of a first partial transmission 1A of the transmission 1.

As shown in FIGS. 11 to 13, the coupling body 41 and the internal gear 3 each have a toothing for the sliding sleeve 40 on the outside.

As shown in FIG. 17, the second end 141B of the second supply device 14 is arranged on the rolling bearing 8 in such a manner that a lubricant flow supplies the rolling bearing 8 and thus the wear of this rolling bearing 8 can be reduced; this applies, for example, in particular when a vehicle with the presented transmission 1 is traveling in reverse.

As already indicated, the transmission 1 includes a first partial transmission 1A. In addition, the transmission shown in FIG. 9 has a second partial transmission 1B and a third partial transmission 1C (cf. FIG. 9).

The first and second partial transmissions 1A, 1B are each implemented as planetary transmissions. Thus, each transmission has a sun gear 2A, 3A, multiple planetary gears or planets 4, 5, a planet carrier 4A, 5A and an internal gear 2, 3 in each case.

As shown in FIGS. 9A and 9B, the planet carrier 5A of the first partial transmission 1A is operatively connected to the sun gear 2A of the second partial transmission 1B so that a torque and a speed can be passed on.

The third partial transmission 1C is designed as a Ravigneaux set. In this regard, the third partial transmission 1C can convert a torque and a speed from the second partial transmission 1B and pass these on to a shaft 42 of the transmission 1.

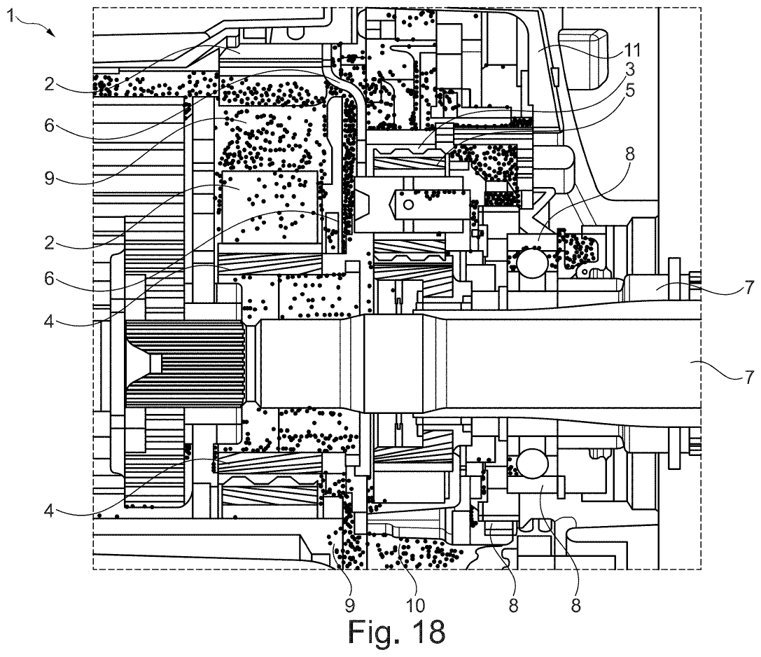

FIG. 18 shows an exemplary embodiment of a planetary gear transmission 1 or a transmission 1 as it can be used in a vehicle for engaging different gears. The planetary gear transmission 1 includes two internal gears 2, 3. The second internal gear 2 forms an input internal gear, whereas the first internal gear 3 is an output internal gear, in particular a load internal gear. The second internal gear 2 is designed for meshing with a second set of planetary gears 4 or planets and the first internal gear 3 is designed for meshing with a further or first set of planetary gears 5 or planets.

The two internal gears 2, 3 or only the second internal gear 3 is axially connected to a support disc 6 or a support plate 6, which provides axial forces to support the internal gears 2, 3. In other words, the support disc 6 or support plate 6 serves to form a barrier for lubricant or lubricating oil in order to provide a lubricant sump 10 or transmission sump 10 or to provide a certain level of lubricant in a certain transmission region.

The support disc 6/the support plate 6 is implemented as a sheet metal component formed without cutting methods. The sets of planetary gears 4, 5 are each rotatably positioned on a planet carrier or positioned on a rotor shaft 7 or on a shaft 7 of a drive not shown further. The rotor shaft 7 is supported in a rotor shaft bearing 8 or in a rolling bearing 8, which is arranged on the drive side behind the first internal gear 3 or, with reference to FIG. 18, to the right of the first internal gear 3. A transmission sump 10 filled with lubricating oil 9 or lubricant is arranged beneath the internal gear 3 or in the region of the internal gear 3. This arrangement is enclosed by a transmission housing 11.

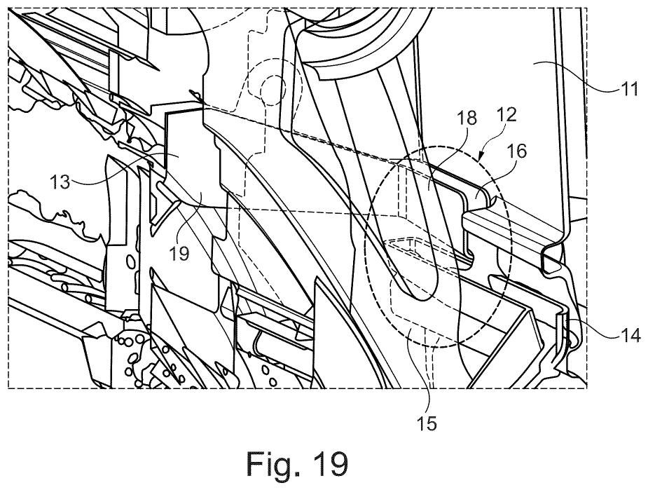

Since the transmission sump 10 is formed behind the support disc 6 or since the transmission sump 10 is delimited by the support plate 6 and the transmission housing 11, splashing lubricating oil 9 is retained during reverse travel or is conveyed against the pumping direction of the gears and the bearings so that the lubricating oil 9 cannot be directed to the rotor shaft bearing 8. In order to prevent this, a system 12 for supplying lubricant to the rolling bearing 8 in the interior of the transmission housing 11 or a device 12 for supplying lubricating oil 9 to the rotor shaft bearing 8 is formed inside of the transmission housing 11, as shown in FIG. 19.

The device 12 or the system 12 is designed in two parts and consists of two oil slides 13, 14 or of a first supply device 13 and a second supply device 14, which are arranged offset in height and partially overlapping one another. In the overflow region 15, an outflow 16 or a discharge device 16 of the first oil slide 13 is located above the second oil slide 14.

Both oil slides 13, 14 or supply devices 13, 14 are designed as inclined in the direction of the rotor shaft bearing 8 and are guided past the first set of planetary gears 4 or a first partial transmission 1A of the transmission 1, which includes the first internal gear 3 and the planetary gears 5, and past a shift fork 17.

The shift fork 17 is used to establish a connection between the internal gear 3 and a coupling body 41 for engaging a selected gear. The rotary movement of the first and second set of planetary gears 4, 5 and the internal gears 2, 3 causes some of the lubricating oil 9 stored in the transmission sump 10 to be thrown up. The swirled-up lubricating oil 9 is collected in both oil slides/supply devices 13, 14 open to the top and, due to the inclination of the oil slides 13, 14, is fed directly to the rotor shaft bearing 8, which is arranged behind the second internal gear 3 or to the right of the internal gear 3.

The lubricating oil 9 collected by the higher mounted first oil slide 13/first supply device 13 flows via the outflow 16 or discharge device 16, which is pressed axially against a rib 39 or against a first housing projection 39 of the transmission housing 11, into the second oil slide 14 or second supply device 14 arranged below, and forms an oil flow with the lubricating oil 9 collected by the second oil slide 14, which drips directly from the second oil slide 14 onto the rotor shaft bearing 8 and thus lubricates it.

Multiple schematic representations of a first part (oil slide 13/supply device 13) of the device for supplying lubricating oil to the rotor shaft bearing 8 or of the system 12 for supplying lubricant to at least one rolling bearing 8 and/or at least one gear in the interior of a transmission housing 11 according to FIG. 18 are shown in FIGS. 1 to 3.

In this regard, FIGS. 1 to 3 show that the oil slide 13 or the supply device 13 is designed in the form of a channel and has a rectangularly protruding region 18 or a second path segment 18, which terminates in the outflow 16 or with the discharge device 16 (FIG. 2). At the main region 19 extending straight or at the first path segment 19, an eyelet 21 formed from the wall region 20 or a first fastening segment 21 formed from the wall region 20 with a passage opening 22 or with a feed-through 22 extends in the plane of the wall region 20 or of the first side part 20 of the first oil slide 13.

An oil pipe 23 or an inflow device 23 with a tubular segment 23A, which also collects swirled-up oil, is formed protruding outwards on the wall region 20/first side part 20 carrying the eyelet 21 (FIG. 1). In an extension of the wall region 20, a centering pin 24 or a projection 24 is arranged behind the oil pipe 23, which extends parallel to the oil pipe 23/to the inflow device 23.

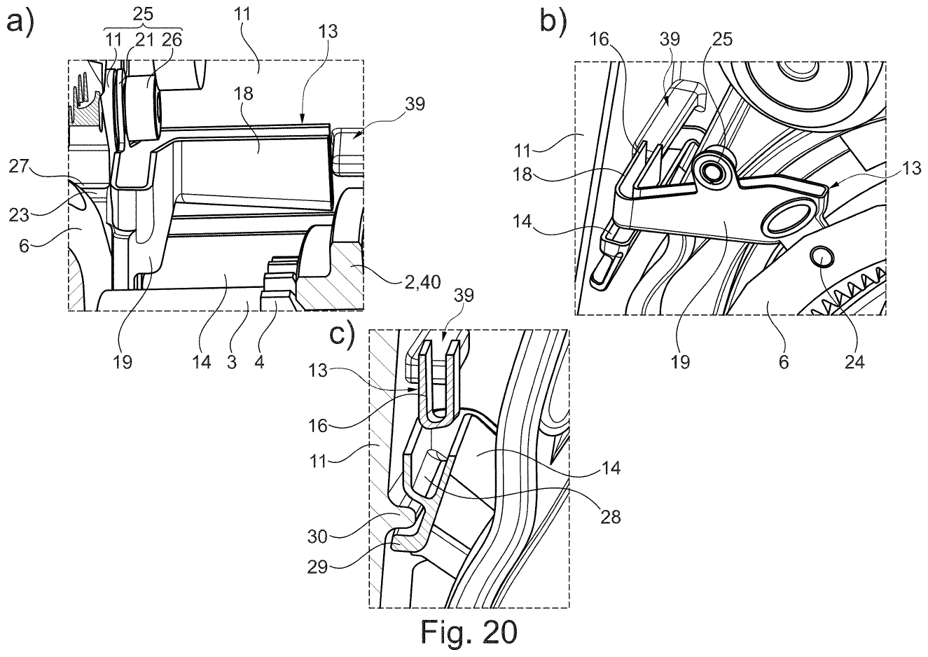

FIG. 20 shows various perspective views of the first part of the device 12 for supplying lubricating oil 9 to a rotor shaft bearing 8 installed in the region of the planetary gear transmission or transmission 1.

FIG. 20a shows the connection of the first oil slide 13 or the connection of the first supply device 13 to the transmission housing 11. Here, the wall region 20 of the main region 19 or the first path segment 19 of the first oil slide 13 lies flat against the transmission housing 11 and is secured thereto by means of a screw connection 25. For the screw connection 25, a screw 26 not shown further is passed through the transmission housing 11 and through the passage opening 22/feed-through 22 of the eyelet 21 or the first fastening segment 21 and secured.

The oil pipe 23 or the inflow device 23 with a tubular segment 23A protrudes at a distance through a passage opening 27 or through a passage 27 of the support disc 6, while the centering pin 24/projection 24 as shown in FIG. 20 b is held in the support disc 6.

As can be seen from FIG. 20c, the outflow 16 or the discharge device 16 of the first oil slide 13/first supply device 13 terminates directly above an exit region 28 of the second oil slide 14/second supply device 13, which engages with a retaining lip 29 or with a retaining clamp 29 under a further rib-shaped projection 30 or a second housing projection 30 of the transmission housing 11 and thus secures the second oil slide 14 to the transmission housing 11.

A more detailed view of the design of the second oil slide 14 or the second supply device 14 is shown by means of multiple perspective views in FIGS. 4, 5 and 6. The second oil slide 14 is also designed in the form of a channel and forms a right angle between two arms 31 and 32 or between a first and second path segment 31, 32 of the lubricant channel 141 (FIG. 4).

The already described retaining lip 29 or retaining clamp 29 (FIG. 5) extends almost under the entire first arm 31 or under the first path segment 31. At the end of the second arm 32/of the second path segment 31 of the second oil slide 14 or of the second supply device 14, a cast-on centering bolt 34 of a fastening device of the supply device 14 extends transversely to the oil outlet 33 or to the discharge device 33. The centering bolt 34 tapers to a point on one side and has a flat surface 35 or pressure surface 35 on the opposite side (FIG. 6).

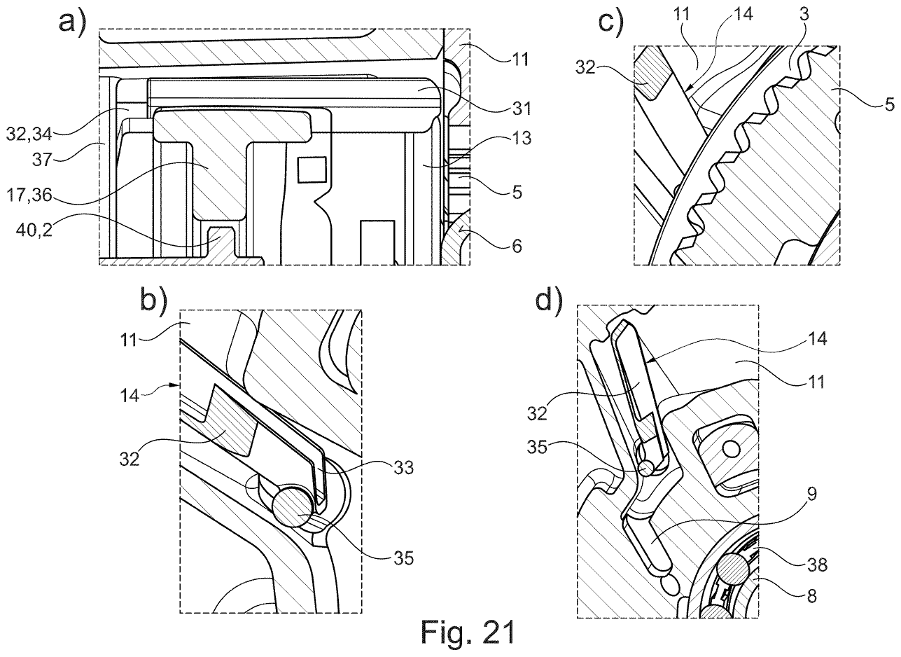

FIG. 21 shows various perspective views of the second supply device 14 of the system 12 or of the device 12 for supplying lubricating oil 9 to a rotor shaft bearing 8 installed in the transmission 1.

FIG. 21a shows the first arm 31 or the first path segment 31 of the second supply device 14 in the transmission 1 as well as an inserted sliding sleeve carrier 36.

In this regard, the second arm 32 of the second oil slide 14 or the second path segment 32 of the second supply device 14 protrudes to the rear or downwards from the first arm 31.

While the flat surface 35 of the centering bolt 34 is located opposite the sliding sleeve carrier 36, the tip of the centering bolt 34 engages in a motor housing 37 or in the transmission housing 11 on the side of the second arm 32 opposite the flat surface 35, which is shown in FIG. 21b.

FIG. 21c illustrates that the second arm 32 of the second oil slide 14 or the second path segment 32 of the second supply device 14 extends behind or to the right of the second internal gear 3 and terminates above the rotor shaft bearing 8 as shown in FIG. 21d. Here, the lubricating oil 9 drips onto the rotor shaft bearing 8 located underneath, in particular into channels 38 provided for this purpose on the rotor shaft bearing 8, with which the rotor shaft bearing 8 is lubricated.

### REFERENCE NUMERALS

1 Transmission
1A First partial transmission
1B Second partial transmission
2 Internal gear
2A Sun gear
3 Internal gear
3A Sun gear
4 Planetary gear/planet
4A Planet carrier
5 Planetary gear/planet
5A Planet carrier
6 Support disc/support device-support plate
6A Bore/feed-through
7 Rotor shaft/shaft
8 Rotor shaft bearing/rolling bearing
9 Lubricating oil
10 Transmission sump/lubricant sump
11 Transmission housing
12 Device for supplying lubricating oil to the rotor shaft bearing/system
13 Oil slide/supply device
131 Lubricant channel
131A First end of the lubricant channel
131B Second end of the lubricant channel
14 Oil slide/supply device
141 Lubricant channel
141A First end of the lubricant channel
141B Second end of the lubricant channel
15 Overflow region
16 Outflow of the first oil slide 13/discharge device
17 Shifting device-shift fork
18 Rectangularly protruding region of the first oil slide/second path segment
19 Main region of the first oil slide/first path segment
20 Wall region of the first oil slide/first side part
20A Second side part
20B Bottom part
21 Eyelet/fastening device-first fastening segment
22 Passage opening/fastening device-feed-through
23 Oil pipe/inflow device
23A Tubular segment
24 Centering pin/fastening device-projection
24A Fastening device-second fastening segment
25 Screw connection
26 Screw
27 Passage opening of the support disc/passage
28 Exit region of the second oil slide
29 Retaining lip/fastening device-retaining clamp
30 Rib-shaped projection/second housing projection
31 First arm of the second oil slide/first path segment
32 Second arm of the second oil slide/second path segment
33 Oil outlet of the second arm of the second oil slide/discharge device
34 Centering bolt/fastening device-pressure surface
35 Flat surface of the centering bolt/fastening device-pressure surface
36 Sliding sleeve carrier
37 Housing/transmission housing
38 Channel of the rotor shaft bearing
39 Rib of the transmission housing/first housing projection
40 Shifting device-sliding sleeve
41 Support device-coupling body
42 Shaft

1. A supply device for supplying a lubricant to at least one rolling bearing or at least one gear in a transmission housing, comprising:
a lubricant channel having at least two path segments, wherein
the at least two path segments are arranged at an angle to one another in order to circumvent an obstacle within the transmission housing.

2. The supply device according to claim 1,
wherein the lubricant channel comprises a first path segment and a second path segment, and
wherein the first path segment and the second path segment together form an L-shape.

3. The supply device according to claim 1,
wherein the lubricant channel comprises a bottom part, a first side part and a second side part which together form a U-shaped cross-section, and
wherein the lubricant channel or its bottom part has a slope so that the lubricant can flow along the lubricant channel from a first end of the lubricant channel to a second end of the lubricant channel.

4. The supply device according to claim 1,
Wherein the supply device has an inflow device and a discharge device for receiving the lubricant at one location and discharging it at another location,
wherein the inflow device comprises a first path segment of the lubricant channel, or
wherein the inflow device has a tubular or a generally cylindrical segment through which the lubricant can flow, and wherein the tubular or generally cylindrical segment of the inflow device opens into one of the at least two path segments in order to additionally supply the one of the at least two path segments with the lubricant.

5. The supply device according to claim 1,
wherein the supply device has a fastening device for fastening to the transmission housing,
wherein the fastening device has a first fastening segment with a feed-through for a screw or for a rivet, and
wherein the fastening device has a second fastening segment with a projection for engagement in a bore or in a feed-through in the transmission housing.

6. The supply device according to claim 1,
wherein the supply device has a fastening device for fastening to the transmission housing, and
wherein the fastening device comprises a retaining clamp with which a second housing projection of the transmission housing can be clamped.

7. A system for supplying the lubricant to at least one rolling bearing or at least one gear in an interior of the transmission housing, comprising:
a first supply device according to claim 1, and
a second supply device according to claim 1.

8. The system according to claim 7,
wherein the first supply device has a fastening device for fastening to the transmission housing, which has a first fastening segment or a second fastening segment, and
wherein the second supply device has a fastening device for fastening to the transmission housing, which comprises a centering bolt or a retaining clamp.

9. A transmission for a vehicle with a lubricant supply in both directions of travel, having:
at least one system for supplying the lubricant to at least one rolling bearing or at least one gear in the interior of the transmission housing according to claim 7,
a shifting device with a movable shifting element,
at least one rolling bearing for a shaft, and
the transmission housing which encloses at least the at least one rolling bearing or which supports the at least one rolling bearing,
wherein the first supply device and the second supply device of the system are arranged on the transmission housing in such a manner that a flow of the lubricant around the movable shifting element to the at least one rolling bearing can be ensured.

10. The transmission according to claim 9,
wherein the transmission housing has a first housing projection, against which a second end of the lubricant channel of the first supply device rests in a contacting manner in order to achieve a clamping of the second end in the direction of a second path segment of the lubricant channel and thus a fixation of the second path segment,
wherein a fastening device of the second supply device is attached to the transmission housing,
wherein the transmission housing has a second housing projection for the fastening device, and
wherein a retaining clamp of the fastening device of the second supply device clamps the second housing projection.
